(19) United States
(12) Patent Application Publication
(10) Pub. No.: US 2008/0198213 A1
(43) Pub. Date: Aug. 21, 2008

(54) ULTRAVIOLET-RAY CURABLE INK COMPOSITION, INKJET RECORDING METHOD AND APPARATUS, AND INK CONTAINER

(75) Inventors: Chiyoshige Nakazawa, Suwa-shi (JP); Takashi Oyanagi, Suwa-shi (JP); Keitaro Nakano, Matsumoto-shi (JP); Ueda Masahiro, Kyoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/031,183

(22) Filed: Feb. 14, 2008

(30) Foreign Application Priority Data
Feb. 15, 2007 (JP) 2007-035437
Feb. 12, 2008 (JP) 2008-030638

(51) Int. Cl. B41J 2/01; C08G 77/60

(52) U.S. Cl. 347/100; 528/10

(57) ABSTRACT

The present invention provides an ultraviolet ray-curable ink composition containing a polysilane compound having a structure represented by the following formula (1):

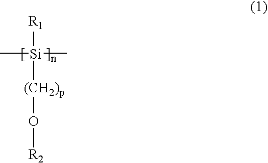

wherein n represents a positive integer; p represents an integer of 2 or more and not more than 10; and R₁ and R₂ each independently represents a substituent. Also disclosed are an inkjet recording method using the composition, and an ink container and an inkjet recording apparatus, each containing the ink composition.

### FIELD OF THE INVENTION

The present invention relates to an ink composition using a polysilane compound, the ink composition being an ultraviolet ray-curable ink composition which is curable with ultraviolet rays, has a high rate of curing (polymerization), has excellent storage stability and even when stored at high temperatures, is low in an increase of viscosity.

The present invention also relates to an inkjet recording method using the ultraviolet ray-curing ink composition, and an ink container and an inkjet recording apparatus, each containing the ultraviolet ray-curing ink composition.

### BACKGROUND OF THE INVENTION

An inkjet recording method is a printing method for performing printing by flying small droplets of an ink composition and making them adhere to a recording medium such as paper. This inkjet recording method has a characteristic feature that an image with high dissolution and high definition can be printed at a high speed. In general, an ink composition to be used in the inkjet recording method contains an aqueous solvent as a major component and further contains a colorant Component and a wetting agent such as glycerin for the purpose of preventing clogging from occurring.

Also, in the case where printing is performed on a recording medium into which an aqueous ink composition hardly penetrates, for example, papers and cloths, or plates or films manufactured from a raw material of a metal or a plastic in which an aqueous ink composition does not penetrate, for example, phenol resins, melamine resins, vinyl chloride resins, acrylic resins and polycarbonate resins, the ink composition is required to contain a component capable of stably fixing a colorant to the recording medium. In particular, in the case where printing is performed on a printed wiring board, etc., the ink composition is required to have quick-drying properties or chemical resistance.

In order to meet these requirements, an ink composition containing a component which is polymerized upon irradiation with ultraviolet rays has hitherto been proposed (see, for example, Patent Document 1). An ultraviolet ray-curable ink composition containing a colorant, an ultraviolet ray absorber, a photopolymerization initiator and so on has also been proposed (see, for example, Patent Document 2). According to these ink compositions and inkjet recording methods, it is considered that bleeding of the ink composition into the recording medium can be prevented, thereby enhancing the image quality.

In the foregoing inkjet recording method using an ink composition containing a component which is polymerized upon irradiation with ultraviolet rays, after making the ink composition adhere to the recording medium, ultraviolet rays are irradiated. Then, the photopolymerization initiator in the ink composition produces a radical, etc., whereby an oligomer or a monomer initiates polymerization and is cured. Therefore, the colorant in the ink composition is fixed onto the recording medium. It is thought that according to this fixing, printing with high film strength, solvent resistance and color density and less bleeding and unevenness can be realized.

As to the related-art ultraviolet ray-curable ink compositions, in general, those having high curing properties such as those having a high curing rate were low in storage stability, and a viscosity thereof increased with a lapse of time. When stored at high temperatures, they caused gelation so that not only they could not be applied to inkjet recording, but they could not be used by other recording methods. Conversely, when the storage stability was increased, the curing properties were lowered, and strong irradiation with ultraviolet rays was necessary. As a result, the device became large in size, or the consumed electric power increased. Therefore, such was not favorable.

It is thought that this is caused due to the matter that not only the photopolymerization initiator in the ink composition generates a radical, etc. due to irradiation with ultraviolet rays, but it generates a radical, etc. by thermal energy.

Patent Document 1: JP-A-3-216379

Patent Document 2: U.S. Pat. No. 5,623,001

### SUMMARY OF THE INVENTION

As described previously, in order to meet the requirement for making an enhancement in rate of polymerization and an enhancement in storage stability compatible with each other, various attempts were made. However, the development of an ink composition capable of making “high rate of polymerization” and “high storage stability” compatible with each other has not been successfully achieved yet.

Accordingly, in order to solve the foregoing problems, the invention has been made. An object of the invention is to provide an ultraviolet ray-curable ink composition using a polysilane compound, which has a high rate of curing (polymerization), has excellent storage stability and even when stored at high temperatures, is low in an increase of viscosity.

Other objects of the present invention are to provide an inkjet recording method using the ultraviolet ray-curing ink composition, and an ink container and an inkjet recording apparatus, each containing the ultraviolet ray-curing ink composition.

The present inventors made extensive and intensive investigations. As a result, it has been found that the foregoing object can be achieved by using a polysilane having a special structure as a photopolymerization initiator, leading to accomplishment of the invention.

Specifically, the invention is as follows.

(1) An ultraviolet ray-curable ink composition containing a polysilane compound having a structure represented by the following formula (I).

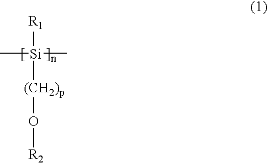

In the foregoing formula (I), n represents a positive integer; p represents an integer of 2 or more and not more than 10; and R₁ and R₂ each independently represents a substituent.

(2) The ultraviolet ray-curable ink composition as set forth above in (1), wherein the polysilane compound has an extinction coefficient at the absorption maximum of 1,000 or more.

(3) The ultraviolet ray-curable ink composition as set forth above in (1) or (2), wherein the polysilane compound has an average molecular weight of 10,000 or more.

(4) The ultraviolet ray-curable ink composition as set forth above in any one of (1) to (3), wherein the polysilane compound has an average molecular weight of 200,000 or more.

(5) The ultraviolet ray-curable ink composition as set forth above in any one of (1) to (4), wherein the polysilane compound is soluble in a hydrophilic acrylate.

(6) An inkjet recording method comprising using the ultraviolet ray-curing ink composition as set forth above in any one of (1) to (5).

(7) An ink container containing the ultraviolet ray-curing ink composition as set forth above in any one of (1) to (5).

(8) An inkjet recording apparatus containing the ultraviolet ray-curing ink composition as set forth above in any one of (1) to (5).

The action mechanism of the invention is not always elucidated yet. However, it is estimated that when the ink composition of the invention contains a polysilane compound, the rate of curing (polymerization) can be increased due to its action as a photopolymerization initiator, and in view of the matter that this polysilane compound has high thermal stability, it is free from decomposition by thermal energy and does not produce a radical, etc., whereby the storage stability can be enhanced.

By using the novel polysilane compound of the invention, it is possible to provide an ultraviolet ray-curable ink composition having a high rate of curing (polymerization) and excellent storage stability.

### BRIEF DESCRIPTION OF THE DRAWINGS

FIG. 1 is a graph showing the measurement chart of ¹H-NMR of a target silane compound.

FIG. 2 is a graph showing the measurement chart of ¹H-NMR of a target polysilane compound.

FIG. 3 is a graph showing the measurement chart of GPC using a target polysilane compound.

FIG. 4 is a graph showing the UV absorption of a target polysilane compound.

### DETAILED DESCRIPTION OF THE INVENTION

The ink composition of the invention contains a polysilane compound having a structure represented by the following formula (I) as a photopolymerization initiator.

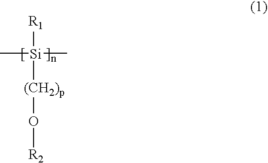

In the foregoing formula (I), n represents a positive integer. The average molecular weight of the foregoing polysilane compound is preferably 10,000 or more (more preferably 200,000 or more). The numerical value of n is preferably such an integer that provides an average molecular weight of this compound of 10,000 or more. In general, the numerical value of n is preferably 1,000 or more.

Also, in the foregoing formula (I), p represents an integer of 2 or more and not more than 10, and more preferably an integer of from 3 to 7.

In the foregoing formula (I), R₁ and R₂ each independently represents a substituent. Examples of the substituent include a linear or branched alkyl group, a cycloalkyl group, a hydroxyl group, a halogen atom, a carboxyl group, an alkoxy group, an acyl group, a cyano group and an acyloxy group.

The foregoing linear or branched alkyl group is preferably a linear or branched alkyl group having from 1 to 12 carbon atoms; more preferably a linear or branched alkyl group having from 1 to 10 carbon atoms; and further preferably a methyl group, an ethyl group, a propyl group, an isopropyl group, an n-butyl group, an isobutyl group, a sec-butyl group, a t-butyl group, a pentyl group, a hexyl group, a heptyl group, an octyl group, a nonyl group or a decyl group. Such an alkyl group may further have a substituent.

The foregoing cycloalkyl group may be monocyclic or polycyclic. Specific examples thereof include groups having a monocyclic, bicyclic, tricyclic or tetracyclic structure having 5 carbon atoms or more or the like. The carbon atom number of the cycloalkyl group is preferably from 6 to 30, and especially from 7 to 25. Such an alicyclic hydrocarbon group may have a substituent.

Examples of the foregoing halogen atom include a chlorine atom, a bromine atom, a fluorine atom and an iodine atom. Also, examples of the foregoing alkoxy group include alkoxy groups having from 1 to 4 carbon atoms, for example, a methoxy group, an ethoxy group, a propoxy group and a butoxy group; and examples of the foregoing acyl group include a formyl group and an acetyl group. Examples of the foregoing acyloxy group include an acetoxy group.

From the standpoint of photoreactivity, the polysilane compound preferably has an extinction coefficient at the absorption maximum of 1,000 or more.

Also, the foregoing polysilane compound is preferably soluble in a hydrophilic acrylate, which is a preferred coating film component of the ink, at a concentration of at least 0.01% by mass and in such a degree that does not cause precipitation even at a usual ink composition concentration, and can be made soluble by adequately choosing the molecular weight and the substituent represented by R₁ and R₂.

The foregoing polysilane can be synthesized according to procedures as described below. The synthesis method is shown while referring to a polysilane having the following structure as an example.

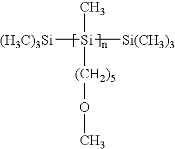

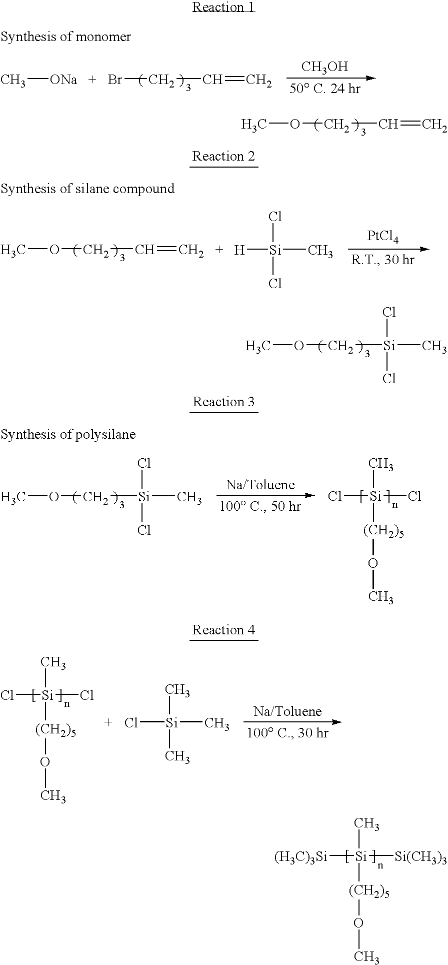

The foregoing reaction 2 follows a reaction as described in R. West, et al., J. Radiation Curing, 13, 35 (1986). In one example of the polysilane obtained by the foregoing reaction 4, the polysilane was a polymer having a two-crest molecular weight distribution of a high-molecular weight body and a low-molecular weight body, one of which is a polymer approximately corresponding to an oligomer, having a weight average molecular weight of 176,214, with the other being a polymer approximately corresponding to an oligomer, having a weight average molecular weight of 6,233. This polysilane had a wavelength at the absorption maximum of 308 nm and an extinction coefficient at the absorption maximum of 5,010.

The polysilane polymerization initiator may be used singly or may be used in admixture with other initiator. In order to achieve the object of the invention that the ink composition has a high rate of curing (polymerization), has excellent storage stability and even when stored at high temperatures, is low in an increase of viscosity, it is preferable that the polysilane polymerization initiator is used singly. Representative examples of the photo-polymerization initiator which can be used jointly with the polysilane polymerization initiator of the invention include benzoinmethyl ether, benzoinethyl ether, isopropylbenzoin ether, isobutylbenzoin ether, 1-phenyl-1,2-propanedione-2-(o-ethoxycarbonyl)oxime, benzil, diethoxyacetophenone, benzophenone, chlorothioxanthone, 2-chlorothioxanthone, isopropylthioxanthone, 2-methylthioxanthone, polychloropolyphenyl and hexachlorobenzene.

Also, photopolymerization catalysts which are commercially available as trade names of VICURE 10 and 30 (available from Stauffer Chemical), IRGACURE 184, 651, 2959, 907, 369, 1700, 1800, 1850 and 819 (available from Ciba Specialty Chemicals), DAROCURE 1173 (available from EM Chemical), QUANTACURE CTX and ITX (available from Aceto Chemical) and LUCIRIN TPO (available from BASF) can be used jointly with the polysilane polymerization initiator of the invention.

The total amount of the photopolymerization initiators is preferably from 0.1 to 10% by mass, and more preferably from 1 to 5% by mass relative to the whole amount of the ink composition.

The major component other than the photopolymerization initiator to be contained in the ink composition of the invention is a polymerizable compound. The polymerizable compound is not particularly limited so far as it is a compound capable of generating a polymerization reaction and curing upon being given any energy, and any compound can be used irrespective of species of monomer, oligomer or polymer. In particular, various publicly known polymerizable monomers capable of generating a polymerization reaction due to an initiation species to be generated from the photopolymerization initiator, which are known as a photo-cationic polymerizable monomer or a photo-radical polymerizable monomer, are preferable.

The polymerizable compound can be used singly or in admixture of plural kinds thereof for the purpose of adjusting a rate of reaction, physical properties of the ink, physical properties of the cured film, etc.

Any of monofunctional monomers, bifunctional monomers and trifunctional or polyfunctional monomers as described in JP-A-2006-28392 can be used as the monomer. It is preferable that all of the monomers have a primary irritation index (PII) of not more than 2.

Also, from the viewpoint of realizing a low viscosity of the ink composition, it is preferable that the use amount of the bifunctional monomer and the trifunctional or polyfunctional monomer is low as far as possible.

Monofunctional monomers, bifunctional monomers and trifunctional or polyfunctional monomers each having a PII value of not more than 2, which can be used in the ink composition of the invention, are exemplified in Table 1.

TABLE 1

| | | |
|---|---|---|
| | Viscosity | |
| [Substance name] | (mPa · s) | P.I.I. |

Monofunctional monomer

| | | |
|---|---|---|
| (2-Methyl-2-ethyl-1,3-dioxolan-4-yl)methyl methacrylate (MEDOL-10, available from Osaka Organic Chemical Industry Ltd.): | 5.1 | 1.3 |
| (2-Methyl-2-isobutyl-1,3-dioxolan-4-yl)methyl acrylate (MIBDOL-10, available from Osaka Organic Chemical Industry Ltd.): | 5.3 | 1.0 |
| Phenoxyethyl acrylate (VISCOAT #192, available from Osaka Organic Chemical Industry Ltd.): | 3.3 | 1.7 |
| Isobonyl acrylate (IBXA, available from Osaka Organic Chemical Industry Ltd.): | 2.6 | 0.6 |
| Methoxy diethylene glycol monoacrylate (BLEMMER PME-100, available from NOF Corporation): | 2 | 0.7 |
| Acryloyl morpholine (ACMO, available from Kohjin Co., Ltd.): | 12 | 0.5 |

Bifunctional monomer

| | | |
|---|---|---|
| Ethylene glycol dimethacrylate (LIGHT-ESTER EG, available from Kyoeisha Chemical Co., Ltd.): | 3 | 0.6 |
| Diethylene glycol dimethacrylate (LIGHT-ESTER 2EG, available from Kyoeisha Chemical Co., Ltd.): | 5 | 0.5 |
| Tripropylene glycol diacrylate (ARONIX M-220, available from Toagosei Co., Ltd.): | 12 | 1.6 |
| 1,9-Nonanediol diacrylate (VISCOAT #260, available from Osaka Organic Chemical Industry Ltd.): | 21 | 2.0 |
| Polyethylene glycol #400 diacrylate (NK ESTER A400, available from Shin-Nakamura Chemical Co., Ltd.): | 58 | 0.4 |
| Tetraethylene glycol dimethacrylate (NK ESTER 4G, available from Shin-Nakamura Chemical Co., Ltd.): | 14 | 0.5 |
| 1,6-Hexanediol dimethacrylate (NK ESTER HD-N, available from Shin-Nakamura Chemical Co., Ltd.): | 6 | 0.5 |
| Neopentyl glycol dimethacrylate (NK ESTER NPG, available from Shin-Nakamura Chemical Co., Ltd.): | 7 | 0.0 |
| 2-Hydroxy-1,3-dimethacryloxypropane (NK ESTER 701, available from Shin-Nakamura Chemical Co., Ltd.): | 37 | 0.6 |
| 1,4-Butanediol dimethacrylate (BD, available from Shin-Nakamura Chemical Co., Ltd.): | 7 | 2.0 |

Trifunctional or polyfunctional monomer

| | | |
|---|---|---|
| Trimethylolpropane trimethacrylate (NK ESTER TMPT, available from Shin-Nakamura Chemical Co., Ltd.): | 42 | 0.8 |
| Trimethylolpropane modified triacrylate (VISCOAT #360, available from Osaka Organic Chemical Industry Ltd.): | 55 | 1.5 |
| Trimethylolpropane PO-modified triacrylate (NEW FRONTIER TMP-3P, available from Dai-ichi Kogyo Seiyaku Co., Ltd.): | 60 | 0.1 |
| Glycerin PO-modified triacrylate (VISCOAT #GPT, available from Osaka Organic Chemical Industry Ltd.): | 75 | 0.8 |

The viscosity in the foregoing table is a measured value at 25° C.

The ink composition of the invention may contain an oligomer other than the foregoing monomer as the polymerizable compound.

The “oligomer” which can be used in the ink composition of the invention is a molecule having a medium-class relative molecular mass and refers to one having a structure constituted by a small number of repetitions (generally from about 2 to 20 repetitions) of a unit obtained substantially or conceptionally from a molecule having a small relative molecular mass. Also, the oligomer which is used in the invention is called a photopolymerizable prepolymer, a base lysine or an acrylic oligomer.

Since the oligomer has from one to several acryloyl groups as a functional group, it has properties that a polymerization reaction with a monomer, etc. is generated upon irradiation with ultraviolet rays or other means to cause crosslinking and polymerization.

Examples of the oligomer which is used in the invention include polyester acrylates, polyurethane acrylates, epoxy acrylates, polyether acrylates, oligo acrylates, alkyd acrylates and polyol acrylates depending upon the molecular structure which constitutes a skeleton. Of these, polyester acrylates and polyurethane acrylates are preferable.

As the oligomer which is used in the invention, ones having a molecular weight ranging from about 500 to 20,000, and preferably from about 5,000 to 10,000 are useful.

Furthermore, the ink composition of the invention may contain a dendritic polymer as the polymerizable compound. The dendritic polymer can be roughly classified into six structures as described below (see Keigo AOI and Masaaki KAKIMOTO Ed., Dendritic Polymers—Highly functionalized world by which the multi-branched structure is widened—(in Japanese), published by NTS Inc.).

I: Dendrimer

II: Linear dendritic polymer

III: Dendri-graft polymer

IV: Hyperbranched polymer

V: Star-hyperbranched polymer

VI: Hyper-graft polymer

Of these, I to III have a degree of branching (DB) of 1 and have a defect-free structure, whereas IV to VI have a random branched structure which may contain a defect. In particular, as compared with generally used linear high-molecular weight compounds, a dendrimer has a possibility to dispose a reactive functional group in a high density and with concentration on the outermost plane thereof and is highly expected as a functional high-molecular weight material. Also, a hyperbranched polymer, a dendri-graft polymer and a hyper-graft polymer are not comparable to the dendrimer but have a possibility to introduce a number of reactive functional groups on the outermost layer thereof and have excellent curing properties.

Different from conventional linear high-molecular weight compounds or branched high-molecular weight compounds, these dendritic polymers repeat a three-dimensional branched structure and are highly branched. For that reason, as compared with linear high-molecular weight compounds having the same molecule, the dendritic polymers have a possible to control the viscosity on a low level.

Examples of a synthetic method of a dendrimer which can be used in the invention include a divergent method in which the synthesis is performed from the center toward the outside and a convergent method in which the synthesis is performed from the outside toward the center.

As the dendrimer, hyperbranched polymer, dendri-graft polymer and hyper-graft polymer which can be used in the invention, ones which are a solid at room temperature and which have a number average molecular weight ranging from 1,000 to 100,000 are desirable; and in particular, ones having a number average molecular weight ranging from 2,000 to 50,000 are preferably used. In the case where the polymer is not a solid at room temperature, the maintenance properties of a formed image become worse. Also, in the case where the molecular weight is lower than the foregoing range, a fixed image becomes brittle; whereas in the case where the molecular weight exceeds the foregoing range, even when the addition amount is decreased, the viscosity of an ink is excessively high so that the ink is not practically useful in view of a flying characteristic.

Also, the dendrimer, hyperbranched polymer, dendri-graft polymer and hyper-graft polymer which can be used in the invention are preferably a dendrimer, a hyperbranched polymer, a dendri-graft polymer and a hyper-graft polymer, respectively, each of which has a radical polymerizable functional group on the outermost plane thereof. By employing a structure in which radical polymerization can be achieved on the outermost plane thereof, a polymerization reaction rapidly proceeds.

Examples of the polymer having a dendrimer structure include amidoamine based dendrimers (as described in U.S. Pat. Nos. 4,507,466, 4,558,120, 4,568,737, 4,587,329, 4,631,337 and 4,694,064) and phenyl ether based dendrimers (as described in U.S. Pat. No. 5,041,516 and Journal of American Chemistry, Vol. 112, pages 7638 to 7647 (1990)). As to the amidoamine based dendrimer, a dendrimer having a terminal amino group and a methyl carboxylate group is commercially available as “STARBURST™ (PAMAM)” from Aldrich. Also, the terminal amino group of such an amidoamine based dendrimer can be allowed to react with an acrylic acid derivative or a methacrylic acid derivative of every kind to synthesize an amidoamine based dendrimer having a corresponding terminal, which is then provided for use.

Examples of the acrylic acid derivative or methacrylic acid derivative which can be used include acrylic acid or methacrylic acid alkyl esters of methyl, ethyl, n-butyl, t-butyl, cyclohexyl, palmityl, stearyl, etc.; and acrylic acid or methacrylic acid alkylamides of acrylamide, isopropylamide, etc.

Also, as to the phenyl ether based dendrimer, various compounds are described in, for example, Journal of American Chemistry, Vol. 112, pages 7638 to 7647 (1990). For example, it is described that 3,5-dihydroxybenzyl alcohol is used and allowed to react with 3,5-diphenoxybenzyl bromide to synthesize a second-generation benzyl alcohol; an OH group thereof is converted to Br by using CBr₄ and triphenylphosphine; thereafter, the resulting benzyl alcohol is similarly allowed to react with 3,5-dihydroxybenzyl alcohol to synthesize a next-generation benzyl alcohol; and subsequently, the foregoing reactions are repeated to synthesize a desired dendrimer. As to the phenyl ether based dendrimer, the terminal can be substituted with one having a chemical structure of every kind in place of the terminal benzyl ether linkage. For example, in synthesizing the dendrimer as described in Journal of American Chemistry, Vol. 112, pages 7638 to 7647 (1990), by using an alkyl halide of every kind in place of the foregoing benzyl bromide, a phenyl ether based dendrimer having a terminal structure having a corresponding alkyl group is obtainable. Besides, polyamine based dendrimers (as described in Macromol. Symp., 77, 21 (1994)) and derivatives thereof having a modified terminal group can be used.

As the hyperbranched polymer, for example, hyperbranched polyethylene glycol can be used. The hyperbranched polymer is one obtained by synthesizing a target polymer in one stage by using a monomer having two or more reaction points of one kind corresponding to a branched portion and only one reaction point of another kind corresponding to a connecting portion in one molecule thereof (see Macromolecules, Vol. 29, pages 3831 to 3838 (1996)). Examples of a monomer for the hyperbranched polymer include 3,5-dihydroxybenzoic acid derivatives. When an example of the production of the hyperbranched polymer is concerned, poly[bis(triethylene glycol)benzoate] which is a hyperbranched polymer can be synthesized by heating methyl 3,5-bis((8′-hydroxy-3′,6′-dioxaoctyl)oxy)benzoate which is a hydrolyzate of methyl 3,5-bis((8′-(t-butyldiphenyloxy)-3′,6′-dioxaoctyl)oxy)benzoate obtainable from 1-bromo-8-(t-butyldiphenyloxy)-3,6-dioxaoctane and methyl 3,5-dihydroxybenzoate together with dibutyltin diacetate under a nitrogen atmosphere.

In the case where 3,5-dihydroxybenzoic acid is used, since the hyperbranched polymer terminal group is a hydroxyl group, a hyperbranched polymer having a terminal group of every kind can be synthesized by using an appropriate alkyl halide with respect to this hydroxyl group.

In a monodispersed polymer or hyperbranched polymer having a dendrimer structure or the like, its characteristic is dominated by a chemical structure of the principal chain and a chemical structure of the terminal group. In particular, its characteristic is largely different depending upon a difference of the terminal group or the substituent in the chemical structure. In particular, a polymer having a polymerizable group in a terminal thereof has a large gelation effect after photoreaction and is useful because of its reactivity. The dendrimer having a polymerizable group is obtained through chemical modification with a polymerizable group-containing compound in a terminal of a polymer having a basic atomic group (for example, an amino group, a substituted amino group and a hydroxyl group) in a terminal thereof.

For example, the dendrimer having a polymerizable group is synthesized by adding, for example, an isocyanate group-containing vinyl compound to a polyfunctional compound obtained by subjecting an amino based dendrimer to Michael addition with an active hydrogen-containing (meth)acrylate based compound. Also, a dendrimer having a polymerizable group in a terminal thereof is obtained by allowing an amino based dendrimer to react with (meth)acrylic acid chloride, etc Examples of such a vinyl compound capable of giving a polymerizable group include compounds having a radical polymerizable, ethylenically unsaturated bond. Examples of such a compound having a radical polymerizable, ethylenically unsaturated bond include unsaturated carboxylic acids, for example, acrylic acid, methacrylic acid, itaconic acid, crotonic acid, isocrotonic acid and maleic acid, and salts thereof; and various compounds having a radical polymerizable, ethylenically unsaturated bond as described below.

Furthermore, examples of the polymerizable group include cationic polymerizable group-containing terminal groups. Such a terminal group can be introduced by allowing a compound having a polymerizable group which is polymerized upon cationic polymerization (for example, an epoxy group and an oxetanyl group), such as cyclic ether compounds (for example, oxirane and oxetane), alicyclic polyepoxides, polyglycidyl esters of a polybasic acid and polyglycidyl ethers of a polyhydric alcohol, to react with the foregoing amino based dendrimer. For example, by allowing chloromethyl oxirane to react with the amino based dendrimer, a cationic polymerizable group of an epoxy type can be introduced in a terminal thereof. Besides, examples of the terminal group include cationic polymerizable groups selected among styrene derivatives, vinylnaphthalene derivatives, vinyl ethers and N-vinyl compounds.

In the invention, an allyl group-containing compound or an N-vinyl group-containing compound is preferably used as the polymerizable compound.

In the invention, the allyl group-containing compound as the polymerizable compound is a general term for compounds having a 2-propenyl structure (—CH₂CH═CH₂). The 2-propenyl group is also called an allyl group and considered to be a trivial name according to the IUPAC nomenclature.

Examples of the allyl group-containing compound include allyl glycol (available from Nippon Nyukazai Co., Ltd.); trimethylolpropane diallyl ether, pentaerythritol triallyl ether and glycerin monoallyl ether (all of which are available from Daiso Co., Ltd.); and allyl group-containing polyoxyalkylene compounds available as trade names including UNIOX, UNILUB, POLYCERIN and UNISAFE (all of which are available from NOF Corporation).

In the invention, examples of the N-vinyl group-containing compound include N-vinylformamide, N-vinylcarbazole, N-vinylacetamide, N-vinylpyrrolidone, N-vinylcaprolactam and derivatives thereof. Of these, N-vinylformamide is especially preferable.

The colorant which is used in the ink composition of the invention may be any of a dye and a pigment. In the case where the penetration of a coloring component in the ink composition is inhibited by the action of insolubilization or thickening of the ink composition or the like, the pigment which is dispersed in the ink is more advantageous than the dye which is dissolved in the ink.

As the dye to be used, various dyes which are usually used in the inkjet recording, for example, direct dyes, acid dyes, food dyes, basic dyes, reactive dyes, disperse dyes, vat dyes, soluble vat dyes and reactive disperse dyes can be used.

As the pigment to be used, inorganic pigments and organic pigments can be used without particular limitations.

As the inorganic pigment, in addition to titanium oxide and iron oxide, carbon blacks as produced by a publicly known method such as a contact method, a furnace method and a thermal method can be used. Also, as the organic pigment, azo pigments (including azo lakes, insoluble azo pigments, condensed azo pigments and chelate azo pigments), polycyclic pigments (for example, phthalocyanine pigments, perylene pigments, perinone pigments, anthraquinone pigments, quinacridone pigments, dioxazine pigments, thioindigo pigments, isoindolinone pigments and quinoflarone pigments), dye chelates (for example, basic dye type chelates and acid dye type chelates), nitro pigments, nitroso pigments, aniline black, etc. can be used.

In order to enhance the preservability of the ink composition, a polymerization inhibitor can be added in an amount of from 200 to 20,000 ppm as other component. Since it is preferable that an ultraviolet ray-curable ink is injected after reducing the viscosity upon beating, it is preferable to charge a polymerization inhibitor for the purpose of preventing head clogging by thermal polymerization or the like.

Besides, a surfactant, a leveling additive, a matting agent, a polyester based resin for the purpose of adjusting physical properties of the film, a polyurethane based resin, a vinyl based resin, an acrylic resin, a rubber based resin and a wax can be added as the need arises. In order to improve adhesion to a recording medium, it is also effective to add a trace amount of an organic solvent. In that case, it is effective to add the organic solvent in an amount falling within the range where a problem is not caused with respect to solvent resistance or VOC, and its amount is from 0.1 to 5% by mass, and preferably from 0.1 to 3% by mass.

Also, it is preferable in view of use that the ink composition of the invention has a viscosity of not more than 100 mPa·s at 25° C.

The ink composition of the invention can be applied to all of publicly known customary image recording and printing methods. The ink composition of the invention can be applied to image recording and printing methods, for example, an inkjet method, an offset method, a gravure method and a thermal transfer method. In particular, the ink composition of the invention is suitable for inkjet recording.

In the inkjet recording method using the ink composition of the invention, the ink composition is made to adhere to a recording medium, and ultraviolet rays are then irradiated. The photopolymerization initiator generates a radical, etc. by the irradiated ultraviolet rays, and according to this, the monomer (in case of containing the oligomer, inclusive of the oligomer, too) initiates the polymerization reaction, whereby the ink composition is fixed to the recording medium. It is thought that according to this, sharp printing can be achieved with excellent film strength and solvent resistance even on a surface of a medium into which an aqueous medium cannot penetrate, such as metals and plastics.

According to a preferred embodiment of the invention, in case of performing irradiation with ultraviolet rays, the irradiation with ultraviolet rays is performed at a dose of 100 mJ/cm² or more (preferably 500 mJ/cm² or more) and not more than 10,000 mJ/cm² (preferably not more than 5,000 mJ/cm²). What the dose of ultraviolet rays falls within the foregoing range is advantageous because the curing reaction can be sufficiently carried out, and color fading of the coloring agent to be caused due to the irradiation with ultraviolet rays can be prevented from occurring.

Examples of a light source of the irradiation with ultraviolet rays include lamps, for example, a metal halide lamp, a xenon lamp, a carbon arc lamp, a chemical lamp, a low-pressure mercury vapor lamp and a high-pressure mercury vapor lamp. The irradiation with ultraviolet rays can be performed by using a lamp which is commercially available from Fusion System Co., for example, an H lamp, a D lamp and a V lamp.

Also, the irradiation with ultraviolet rays can be performed by an ultraviolet light emitting semiconductor device such as an ultraviolet light emitting diode (ultraviolet LED) and an ultraviolet light emitting semiconductor laser.

Also, in the inkjet recording method using the ink composition of the invention, heating may be performed simultaneously with or after the irradiation with ultraviolet rays.

Examples of a method for performing heating include a method for heating while bringing a heat source into contact with the recording medium; and a method for heating upon irradiation with infrared rays, a microwave (for example, electromagnetic waves having a maximum wavelength of about 2,450 Mhz), etc. or blowing hot air without contacting it with the recording medium.

The ultraviolet ray-curing ink composition according to the present invention can be used while allowing it to be contained in a known ink container or a known inkjet recording apparatus.

### EXAMPLES

The invention will be illustrated in greater detail with reference to the following Examples, but it should not be construed that the invention is limited to these Examples. It is possible for one skilled in the art to carry out not only the Examples as written but also carry out them with various modifications, and such modifications shall also be encompassed by the scope of the appended claims.

### [Synthesis of Polysilane]

### (1) Synthesis of Olefin Compound (See the Right-Hand Side of “Reaction Scheme I” as Shown Below):

A Dimroth condenser and a dropping funnel were installed in a round-bottom flask, and after putting a rotator therein, the inside of the flask was subjected to deoxidation by a vacuum pump. Next, the inside of the flask was returned to atmospheric pressure by using a nitrogen gas, and a nitrogen gas was then flown into the system at a rate of 50 mL/min.

1.00 g (6.84 mmoles) of 5-bromo-1-pentene was dissolved in 10 g of methanol, and the solution was charged in the foregoing flask by using a syringe such that oxygen was not incorporated thereinto. 1.55 g of a 28% by mass methanol solution of sodium methylate (NaOCH₃) was charged in the dropping funnel by using a syringe such that oxygen was not incorporated thereinto. The alcoholate solution in the dropping funnel was gradually dropped in the flask under ice cooling. Thereafter, stirring was carried out for 2 hours. The temperature was raised to room temperature and then further stirring was carried out for 2 hours. Then, the temperature was raise to 50° C. and stirring was carried out over one whole day and night.

After confirming by gas chromatography (GC) that the raw material 5-bromo-1-pentene did not remain in the reaction solution, the reaction solution was poured into 100 mL of pure water. The mixed solution was transferred into a separatory funnel, and 100 mL of hexane was further added thereto. After vigorous stirring, the mixture was allowed to stand, and the hexane layer was taken out. 100 mL of fresh hexane was again added in the separatory funnel in which the aqueous layer remained, and a liquid separation operation was repeated.

The hexane layer obtained by the liquid separation operation was gathered with the previously obtained hexane layer, and the gathered hexane solution was washed with 200 mL of pure water. The washing with pure water was further repeated three times (four times in total). After confirming by gas chromatography (GC) that the methanol did not remain in the hexane solution, 15 g of sodium sulfate was added in the hexane solution as taken out. After allowing the mixture to stand for about one hour, the resulting mixture was filtered to obtain a hexane solution of the desired olefin compound as a filtrate.

### (2) Synthesis of Silane Compound (See the Right-Hand Side of “Reaction Scheme II” as Shown Below):

A Dimroth condenser was installed in a round-bottom flask, and a rotator was put therein. The inside of the flask was subjected to deoxidation by a vacuum pump. The inside of the flask was returned to atmospheric pressure by using a nitrogen gas, and a nitrogen gas was then flown into the system at a rate of 50 mL/min.

The whole of the hexane solution of an olefin compound obtained by the foregoing reaction was charged in the flask by using a syringe such that oxygen was not incorporated thereinto. Thereafter, 1.18 g (10.3 mmoles) of dichloromethylsilane was charged in the flask by using a syringe such that oxygen was not incorporated thereinto. Furthermore, one drop of a 2% by mass xylene solution of a platinum complex (a platinum divinyltetramethyl disiloxane complex which is available from Aldrich) was charged in the flask by using a syringe such that oxygen was not incorporated thereinto.

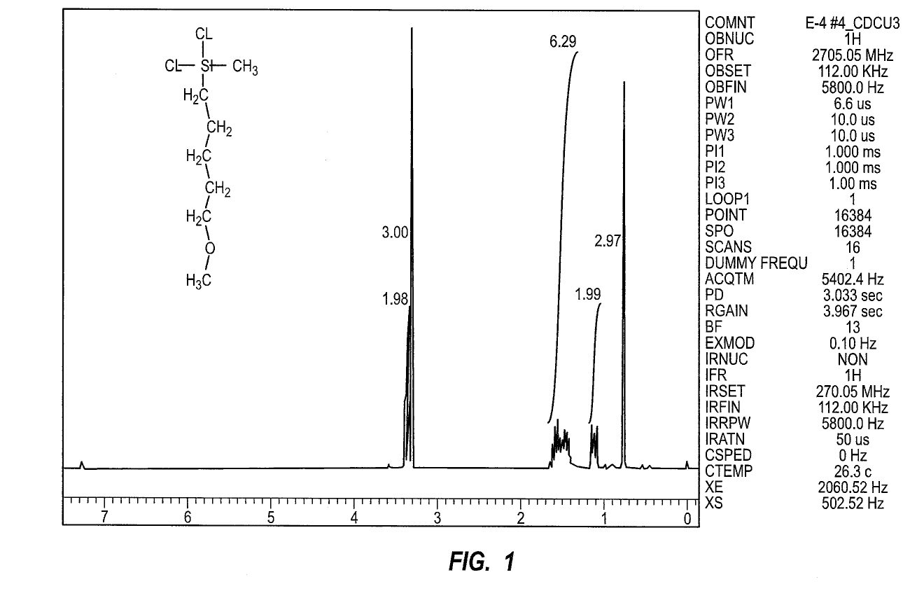

After continuing stirring at room temperature for about one day, the reaction was finished. The reaction solution was first heated at atmospheric pressure; when the evaporation of a volatile matter substantially stopped, the system was evacuated by using a vacuum pump; and the distillation was continued. There was thus obtained a target silane compound at 5 Torr and a distillation temperature of 66° C. This compound was confirmed to be a target silane compound from chemical shift, branching and integration values of signals obtained by the ¹H-NMR measurement (3.35 ppm triplet 2H, 3.30 ppm singlet 3H, 1.4 to 1.7 ppm broad 6H, 1.15 ppm triplet 2H, 0.75 ppm singlet 3H; see FIG. 1 (Solvent used for the measurement: deuterated chloroform)).

### 3) Synthesis of Polysilane (See the Right-Hand Side of “Reaction Scheme III” as Shown Below):

A Dimroth condenser and a mechanical stirrer having a stirring rod provided with a semicircular blade were installed in a round-bottom flask. The inside of the flask was subjected to deoxidation by a vacuum pump. The inside of the flask was returned to atmospheric pressure by using a nitrogen gas, and a nitrogen gas was then flown into the system at a rate of 50 mL/min.

0.60 g (2.80 mmoles) of a 5% by mass toluene solution of the obtained high-purity silane compound was charged in the flask by using a syringe such that oxygen was not incorporated thereinto. Thereafter, 0.0966 g (4.20 mmoles) of metallic sodium was finely cut in a mineral oil until it became in a particulate state that its size was not more than 1 mm and charged together with the mineral oil by vigorously flowing a nitrogen gas from the inside of the system to maintain the inside of the system at a positive pressure while paying attention such that air was not incorporated thereinto. Thereafter, the temperature of the reaction solution was raised to 100° C., and the reaction was continued for about 50 hours.

### 4) Synthesis of Polysilane (See the Right-Hand Side of “Reaction Scheme IV” as Shown Below):

Thereafter, trimethylchlorosilane in an amount (0.122 g, 1.12 mol) that is 0.4 molar times the charged silane compound was charged in the flask by using a syringe such that oxygen was not incorporated thereinto. After cooling to room temperature, an unnecessary residue was filtered off. The resulting filtrate was reprecipitated from methanol. A generated white precipitate was filtered, taken out and then dried to obtain 0.06 g of a target polysilane.

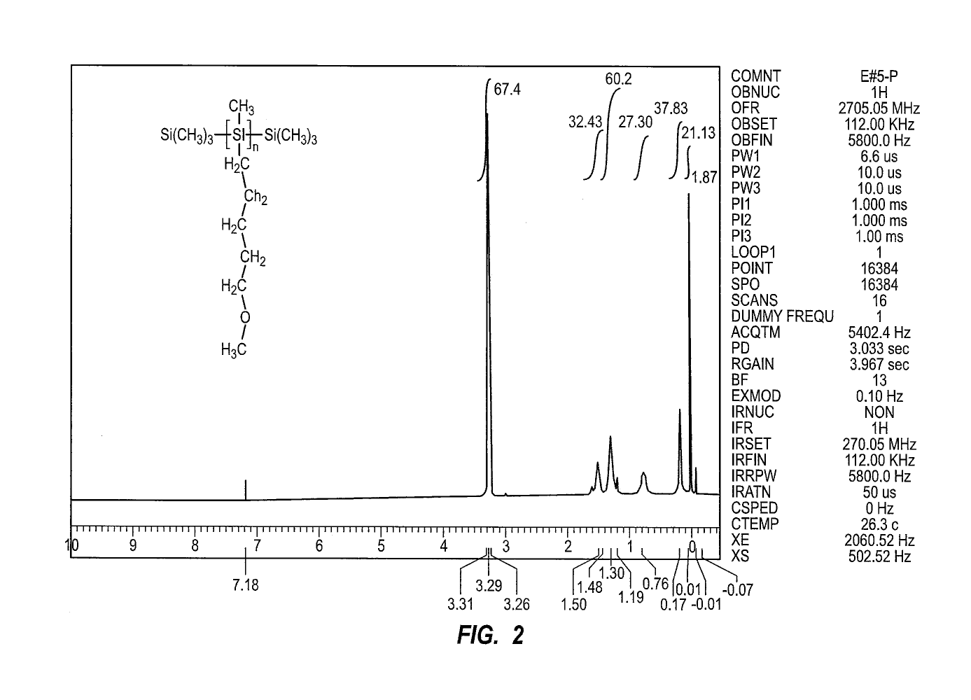

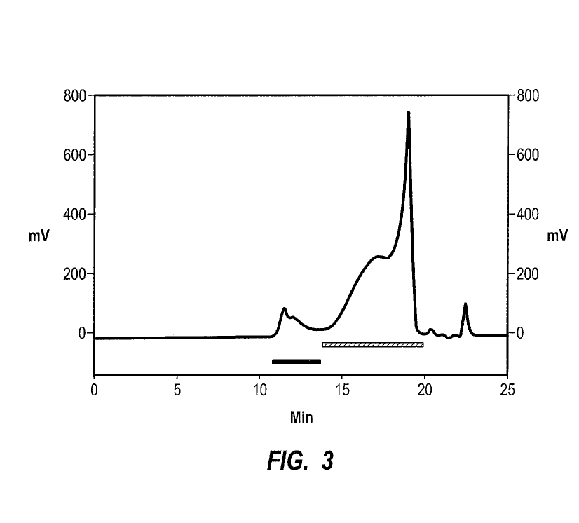

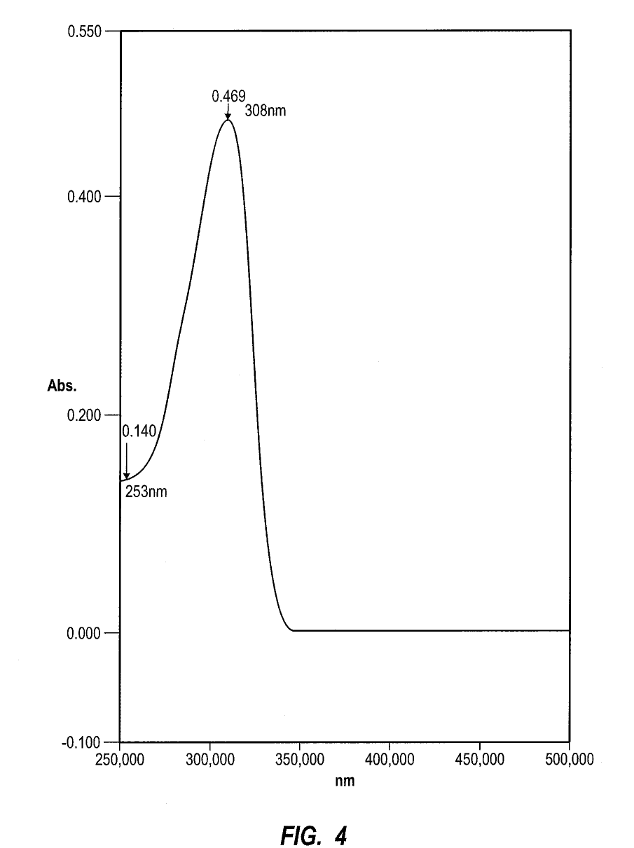

This compound was confirmed to be a target polysilane compound from chemical shift, branching and integration values of signals obtained by the ¹H-NMR measurement (3.35 ppm triplet 2H, 3.30 ppm singlet 3H, 1.5 to 1.6 ppm 2H, 1.3 to 1.4 ppm broad 4H, 0.7 to 0.8 ppm broad 2H, 0.1 to 0.2 ppm broad 3H; see FIG. 2 (Solvent used for the measurement: deuterated chloroform)). It was revealed that the target polysilane compound had a two-crest molecular weight distribution, one of which is a polymer having a peak at 239,811, a number average molecular weight of 151,812, a weight average molecular weight of 176,214 and a degree of polydispersion of 1.161, with the other being a polymer approximately corresponding to an oligomer, having a peak at 945, a number average molecular weight of 1,985, a weight average molecular weight of 6,233 and a degree of polydispersion of 3.141 (see FIG. 3). UV absorption of a 0.936×10⁻⁴ M/THF solution of this polysilane is shown in FIG. 4. This polysilane had a wavelength at the UV absorption maximum of 308 nm and an extinction coefficient at the UV absorption maximum of 5,010 (O.D./M).

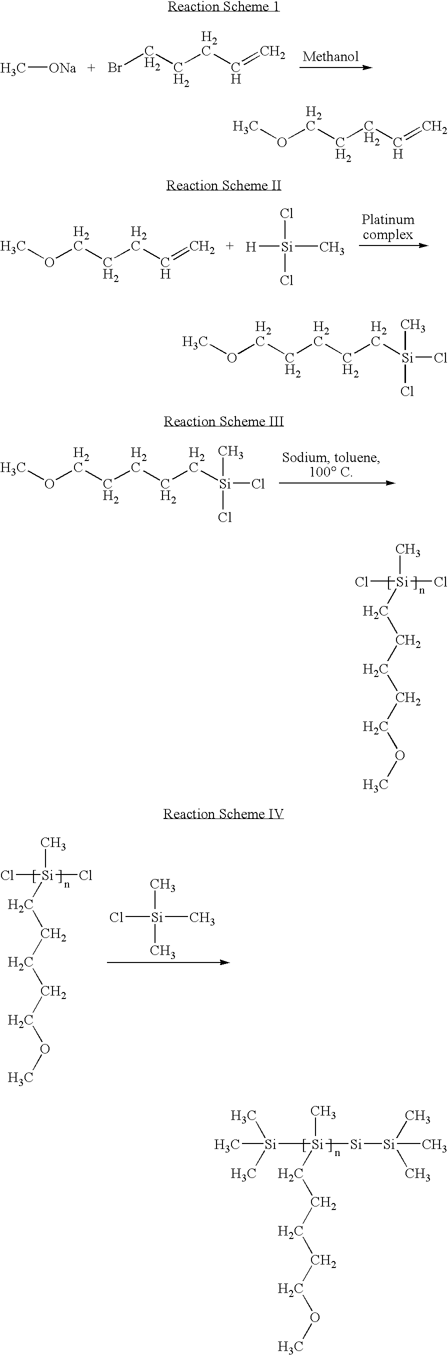

### [Preparation of Pigment Dispersion]

Ethylene glycol monoallyl ether as a monomer was added to 15 parts by mass of C.I. Pigment Black 7 (carbon black) as a coloring agent and 6.0 parts by mass of DISCOALL N-509 (available from Dainichiseika Color & Chemicals Mfg. Co., Ltd.) to make the whole to 100 parts by mass and mixed and stirred to obtain a mixture. This mixture was subjected to a dispersion treatment together with zirconia beads (diameter: 1.5 mm) for 6 hours by using a sand mill (available from Yasukawa Seisakusho). Thereafter, the zirconia beads were separated by a separator to obtain a black pigment dispersion (“Pigment Black-7” in Table 2 set forth below).

Pigment dispersions corresponding to respective colors, namely a cyan pigment dispersion (“Pigment Blue-155” in Table 2 set forth below), a magenta pigment dispersion (“Pigment Violet-19” in Table 2 set forth below) and a yellow pigment dispersion (“Pigment Yellow-155” in Table 2 set forth below) were prepared in the same manner as described previously.

### Example 1

### Preparation of Ink Compositions 1-1 to 1-4; See Table 2 Set Forth Below

MEDOL-10 (acrylic monomer, which is available from Osaka Organic Chemical Industry Ltd.), VISCOAT #360 (trimethylolpropane modified triacrylate as a polyfunctional monomer, which is available from Osaka Organic Chemical Industry Ltd.), the foregoing polysilane and a dispersant (polyoxyalkylene polyalkylene polyamine) were mixed at the formulation (parts by mass) as shown in Table 2 set forth below, to which was then dropped the foregoing pigment dispersion (Pigment Black-7, Pigment Blue-15:3, Pigment Violet-19 or Pigment Yellow-155) while stirring (see the dropping amount as shown in Table 2 set forth below). After completion of the dropping, the mixture was mixed and stirred at normal temperature for one hour, and the resulting mixture was filtered through a 5-μm membrane filter to obtain each of ink compositions 1-1 to 1-4 of Example 1.

The ink compositions 1-1 to 1-4 of Example 1 are shown in Table 2.

Also, each of these ink compositions was measured with respect to “viscosity at 20° C. (unit: mPa·s)”. The results are shown in Table 2. Furthermore, each of these ink compositions was subjected to “curing properties test”, “pencil hardness test”, “printing test” and “storage stability test”. The results of these tests (evaluations) are also shown in Table 2.

### [Curing Properties Test]

Each of the foregoing ink compositions 1-1 to 1-4 of Example 1 was dropped on a glass substrate and subjected to a curing treatment with ultraviolet rays having a wavelength of 365 nm under short-time and low-light quantity conditions at an irradiation intensity of 17 mW/cm² for an irradiation time of 6 seconds in an integrated light amount of 102 mJ/cm². Thereafter, the resulting ink composition was evaluated according to the following evaluation criteria (visual evaluation of curing properties).

### Evaluation Criteria

A: The ink composition is completely cured.

B: The ink composition is substantially cured but not completely.

C: The ink composition is partially cured.

### [Pencil Hardness Test]

A sample having been subjected to a curing treatment in the foregoing method was evaluated for hardness in a method as specified in JIS K5400 (pencil scratch test, handwriting method).

### [Printing Test]

By using an inkjet printer, PX-G900 (available from Seiko Epson corporation), each of the foregoing ink compositions 1-1 to 1-4 of Example 1 was subjected to solid pattern printing at normal temperature and atmospheric pressure by using an OHP film (XEROX FILM (with no frame), available from Fuji Xerox Co., Ltd.) as a recording medium, subjected to printing and curing treatments by an ultraviolet ray irradiation device placed in a paper output port under a curing condition in an integrated light amount of 90 mJ/cm² and then evaluated according to the following evaluation criteria (visual evaluation of curing properties).

### Evaluation Criteria

A: The ink composition is cured in a thin film state on the OHP film.

C: The ink composition is not completely cured on the OHP film.

### [Storage Stability Test]

Each of the foregoing photocurable ink compositions was allowed to stand under an environment at 60° C. for 7 days. An initial viscosity (mPa·s) and a viscosity after standing were measured by a rheometer (MCR-300, available from Physica), and a rate of change in the viscosity was evaluated according to the following criteria. The initial viscosity and the viscosity after standing were measured at 20° C.

AA: The rate of change in the viscosity between the initial viscosity and the viscosity after standing is less than ±5%.

A: The rate of change in the viscosity between the initial viscosity and the viscosity after standing is +5 m or more and less than ±20%.

B: The rate of change in the viscosity between the initial viscosity and the viscosity after standing is ±20% or more.

TABLE 2

| | Example 1 | | | |
|---|---|---|---|---|
| | Ink composition | Ink composition | Ink composition | Ink composition |
| | 1-1 | 1-2 | 1-3 | 1-4 |
| MEDOL-10 (available from Osaka Organic Chemical Industry Ltd.) | 74.0 | 74.0 | 74.0 | 74.0 |
| VISCOAT #360 (available from Osaka Organic Chemical Industry Ltd.) | 14.0 | 14.0 | 14.0 | 14.0 |
| Polysilane | 6.0 | 6.0 | 6.0 | 6.0 |
| Pigment Black-7 | 5.0 | — | — | — |
| Pigment Blue-15:3 | — | 5.0 | — | — |
| Pigment Violet-19 | — | — | 5.0 | — |
| Pigment Yellow-155 | — | — | — | 5.0 |
| Dispersant (polyoxyalkylene polyalkylene polyamine) | 1.0 | 1.0 | 1.0 | 1.0 |
| Viscosity at 20° C. (unit: mPa · s) | 11.5 | 11.8 | 11.7 | 12.0 |
| Results of curing properties test | A | A | A | A |
| Results of pencil hardness test | 2H | 3H | 3H | 3H |
| Results of printing test | A | A | A | A |
| Results of storage stability test | AA | AA | AA | AA |

(Unit: parts by mass)

### Example 2

### Preparation of Ink Compositions 2-1 to 2-4; See Table 3 Set Forth Below

Ally glycol (available from Nippon Nyukazai Co., Ltd.) and N-vinylformamide (available from Dia-Nitrix Co., Ltd.) as polymerizable compounds and VISCOAT #1000 which is a (meth)acryloyl group-containing dendritic polymer (available from Osaka Organic Chemical Industry Ltd.) were used, and the polysilane, dispersant and pigment dispersion as used in Example 1 were mixed therewith at the formulation as shown in Table 3 set forth below. The mixture was then mixed and stirred at normal temperature for one hour, and the resulting mixture was filtered through a 5-μm membrane filter to obtain each of ink compositions 2-1 to 2-4 of Example 2.

The ink compositions 2-1 to 2-4 of Example 2 are shown in Table 3.

Each of these ink compositions was evaluated in the same manners as in Example 1. The results of “viscosity at 20° C. (unit: mPa·s)”, “curing properties test”, “pencil hardness test”, “printing test” and “storage stability test” are shown in Table 3.

TABLE 3

| | Example 2 | | | |
|---|---|---|---|---|
| | Ink composition | Ink composition | Ink composition | Ink composition |
| | 2-1 | 2-2 | 2-3 | 2-4 |
| Allyl glycol (available from Nippon Nyukazai Co., Ltd.) | 53.0 | 53.0 | 53.0 | 53.0 |
| N-Vinylformamide (available from Dia-Nitrix Co., Ltd.) | 25.0 | 25.0 | 25.0 | 25.0 |
| VISCOAT #1000 (available from Osaka Organic Chemical Industry Ltd.) | 12.2 | 12.2 | 12.2 | 12.2 |
| Polysilane | 4.0 | 4.0 | 4.0 | 4.0 |
| Pigment Black-7 | 5.0 | — | — | — |
| Pigment Blue-15:3 | — | 5.0 | — | — |
| Pigment Violet-19 | — | — | 5.0 | — |
| Pigment Yellow-155 | — | — | — | 5.0 |
| Dispersant (polyoxyalkylene polyalkylene polyamine) | 0.8 | 0.8 | 0.8 | 0.8 |
| Viscosity at 20° C. (unit: mPa · s) | 8.6 | 8.4 | 8.7 | 8.3 |
| Results of curing properties test | A | A | A | A |
| Results of pencil hardness test | 2H | 4H | 4H | 3H |
| Results of printing test | A | A | A | A |
| Results of storage stability test | AA | AA | A | AA |

(Unit: parts by mass)

### Comparative Example 1

### Preparation of Ink Compositions 1-1 to 1-4; see Table 4 Set Forth Below

A mixture was prepared using the same components as in Example 1, except for using IRGACURE 1800 (available from Ciba Specialty Chemicals) as a photopolymerization initiator in place of the foregoing polysilane, to thereby give the formulations as shown in Table 4 set forth below. The mixture was then mixed and stirred at normal temperature for one hour, and the resulting mixture was filtered through a 5-μM membrane filter to obtain each of ink compositions 1-1 to 1-4 of Comparative Example 1.

### Comparative Example 2

### Preparation of Ink Compositions 2-1 to 2-4; see Table 5 Set Forth Below

A mixture was prepared using the same components, except for using IRGACURE 1800 (available from Ciba Specialty Chemicals) as a photopolymerization initiator in place of the foregoing polysilane, to thereby give the formulations as shown in Table 5 set forth below. The mixture was then mixed and stirred at normal temperature for one hour, and the resulting mixture was filtered through a 5-μm membrane filter to obtain each of ink compositions 2-1 to 2-4 of Comparative Example 2.

The ink compositions 1-1 to 1-4 of Comparative Example 1 are shown in Table 4; and the ink compositions 2-1 to 2-4 of Comparative Example 2 are shown in Table 5.

Each of these ink compositions was evaluated in the same manners as in Examples 1 and 2. The results of “viscosity at 20° C. (unit: mPa·s)”, “curing properties test”, “pencil hardness test”, “printing test” and “storage stability test” are shown in Tables 4 and 5.

TABLE 4

| | Comparative Example 1 | | | |
|---|---|---|---|---|
| | Ink composition | Ink composition | Ink composition | Ink composition |
| | 1-1 | 1-2 | 1-3 | 1-4 |
| MEDOL-10 (available from Osaka Organic Chemical Industry Ltd.) | 74.0 | 74.0 | 74.0 | 74.0 |
| VISCOAT #360 (available from Osaka Organic Chemical Industry Ltd.) | 14.0 | 14.0 | 14.0 | 14.0 |
| IRGACURE 1800 (available from Ciba Specialty Chemicals) | 6.0 | 6.0 | 6.0 | 6.0 |
| Pigment Black-7 | 5.0 | — | — | — |
| Pigment Blue-15:3 | — | 5.0 | — | — |
| Pigment Violet-19 | — | — | 5.0 | — |
| Pigment Yellow-155 | — | — | — | 5.0 |
| Dispersant (polyoxyalkylene polyalkylene polyamine) | 1.0 | 1.0 | 1.0 | 1.0 |
| Viscosity at 20° C. (unit: mPa · s) | 11.8 | 11.7 | 12.1 | 11.9 |
| Results of curing properties test | C | B | B | C |
| Results of pencil hardness test | — | H | B | — |
| Results of printing test | C | C | C | C |
| Results of storage stability test | A | A | B | B |

(Unit: parts by mass)

TABLE 5

| | Comparative Example 2 | | | |
|---|---|---|---|---|
| | Ink composition | Ink composition | Ink composition | Ink composition |
| | 2-1 | 2-2 | 2-3 | 2-4 |
| Allyl glycol (available from Nippon Nyukazai Co., Ltd.) | 53.0 | 53.0 | 53.0 | 53.0 |
| N-Vinylformamide (available from Dia-Nitrix Co., Ltd.) | 25.0 | 25.0 | 25.0 | 25.0 |
| VISCOAT #1000 (available from Osaka Organic Chemical Industry Ltd.) | 12.2 | 12.2 | 12.2 | 12.2 |
| IRGACURE 1800 (available from Ciba Specialty Chemicals) | 4.0 | 4.0 | 4.0 | 4.0 |
| Pigment Black-7 | 5.0 | — | — | — |
| Pigment Blue-15:3 | — | 5.0 | — | — |
| Pigment Violet-19 | — | — | 5.0 | — |
| Pigment Yellow-155 | — | — | — | 5.0 |
| Dispersant (polyoxyalkylene polyalkylene polyamine) | 0.8 | 0.8 | 0.8 | 0.8 |
| Viscosity at 20° C. (unit: mPa · s) | 8.5 | 8.7 | 8.3 | 8.9 |
| Results of curing properties test | C | B | B | C |
| Results of pencil hardness test | — | H | H | — |
| Results of printing test | C | A | A | C |
| Results of storage stability test | B | B | B | B |

(Unit: parts by mass)

While the present invention has been described in detail and with reference to specific embodiments thereof, it will be apparent to one skilled in the art that various changes and modifications can be made therein without departing from the spirit and scope thereof.

This patent application is based on Japanese Patent Application Nos. 2007-035437 (filed Feb. 15, 2007) and 2008-030638 (filed Feb. 12, 2008), and the contents thereof are herein incorporated by reference.

What is claimed is:

1. An ultraviolet ray-curable ink composition containing a polysilane compound having a structure represented by the following formula (I): 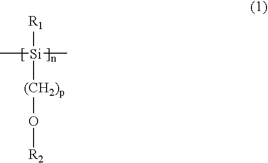
wherein n represents a positive integer; p represents an integer of 2 or more and not more than 10; and R₁ and R₂ each independently represents a substituent.

2. The ultraviolet ray-curable ink composition according to claim 1, wherein the polysilane compound has an extinction coefficient at the absorption maximum of 1,000 or more.

3. The ultraviolet ray-curable ink composition according to claim 1, wherein the polysilane compound has an average molecular weight of 10,000 or more.

4. The ultraviolet ray-curable ink composition according to claim 1, wherein the polysilane compound has an average molecular weight of 200,000 or more.

5. The ultraviolet ray-curable ink composition according to claim 1, wherein the polysilane compound is soluble in a hydrophilic acrylate.

6. An inkjet recording method comprising using the ultraviolet ray-curing ink composition according to claim 1.

7. An ink container containing the ultraviolet ray-curing ink composition according to claim 1.

8. An inkjet recording apparatus containing the ultraviolet ray-curing ink composition according to claim 1.
